(19) United States
(12) Patent Application Publication
(10) Pub. No.: US 2009/0249978 A1
(43) Pub. Date: Oct. 8, 2009

(54) PROCESS FOR PRODUCING AN IMPROVED ASPHALT USING POLYPHOSPHORIC ACID WITH AIR BLOWING

(76) Inventors: Jean-Valery Martin, Princeton, NJ (US); Gaylon Lynn Baumgardner, Jackson, MS (US); Andrew Michael Menapace, Raymond, MS (US); John Medford Dumas, Madison, MS (US)

Correspondence Address: MCCARTER & ENGLISH, LLP HARTFORD;CITYPLACE I, 185 ASYLUM STREET, HARTFORD, CT, 06103, US

(21) Appl. No.: 12/419,851

(22) Filed: Apr. 7, 2009

Related U.S. Application Data
(60) Provisional application No. 61/043,067, filed on Apr. 7, 2008.

(51) Int. Cl. C08L 95/00

(52) U.S. Cl. 106/279; 106/284.1

(57) ABSTRACT

A process is provided for producing an improved asphalt composition is air blown for a reduced period of time prior to addition of polyphosphoric acid. The air blowing process is performed at temperatures and using air volumes typically used for air blown asphalt. The process may be performed using neat asphalt, or it may be used on mixtures of asphalt with flux, slop, or mixtures of flux and slop. After the initial air blowing period, polyphosphoric acid is added to the asphalt. The polyphosphoric acid may be added while the asphalt is at temperature, or the asphalt may be allowed to cool slightly before the addition of the polyphosphoric acid. Following addition of the polyphosphoric acid, the asphalt may undergo further air blowing to obtain desired properties.

This application claims priority under 35 U.S.C. § 119 to U.S. Provisional Application No. 61/043,067 filed on Apr. 7, 2008, the entire contents of which are hereby incorporated by reference.

### FIELD OF THE INVENTION

The present invention is related, in one aspect, to improved processes for the production of air-blown asphalt modified with polyphosphoric acid. In other aspects, the present invention is related to improved asphalt compositions comprising air-blown asphalt modified with polyphosphoric acid and uses of the resulting compositions.

### BACKGROUND

For certain applications, residual or straight run asphalt (sometimes referred to as bitumen) is not suitable for certain uses as it is produced. In many cases, the asphalt is modified through an oxidation process or air blowing process to modify certain properties of the asphalt. In general, this technique can increase the hardness, softening point, pliability and weathering resistance of an asphalt, while decreasing its ductility and susceptibility to changes in temperature.

The prior processes for oxidation of asphalt using air blowing typically involve blowing air through an asphalt stock to oxidize the asphalt. The blowing process is typically performed at temperatures ranging from 400° F. to 550° F., and with air blown at rates of typically about 3000 CFM to produce an asphalt having modified properties as a result of contact with air. In these processes, air blowing is typically performed for periods of up to 20 hours.

Additives have also been used to enhance the overall properties of air blown asphalt and to reduce the process time. One additive currently used in the air blowing process is polyphosphoric acid (PPA). Addition of PPA to the asphalt during the air blowing process typically allows a reduction in the temperature of the asphalt during the blowing process, leading to a reduction in coke formation. The addition of PPA during the air blowing process can also reduce the process time. PPA addition can also aid in producing an asphalt product having a high softening point with higher penetration values over asphalt produced by a blowing process without addition of PPA.

Depending upon the natural origin of the crude oil, asphalts may be produced having very particular and unique properties. Thus, asphalt produced from different sources of crude will behave differently during the blowing process. It has been discovered that some asphalt reacts in the presence of PPA during an air blowing oxidation process to form a solid precipitate in the blowing tower. This phenomena is obviously not desirable and until now has limited the use of PPA with asphalts that react with PPA to form precipitates. Accordingly, it would be desirable to have an air blowing asphalt oxidation process that can be used with PPA to form asphalts having enhanced properties.

### SUMMARY OF THE INVENTION

The present invention is directed to processes for producing improved asphalt compositions. In the process, asphalt is air blown for a reduced period of time prior to addition of polyphosphoric acid. The air blowing process is performed at temperatures and using air volumes typically used for air blown asphalt. The process may be performed using neat asphalt, or it may be used on mixtures of asphalt with flux, slop, or mixtures of flux and slop.

After the initial air blowing period, polyphosphoric acid is added to the asphalt. The polyphosphoric acid may be added while the asphalt is at temperature, or the asphalt may be allowed to cool slightly before the addition of the polyphosphoric acid. Following addition of the polyphosphoric acid, the asphalt may undergo further air blowing to obtain desired properties.

Among the advantages of the process is that an air blown asphalt having improved properties can be produced while minimizing or eliminating precipitates that form in prior air blowing processes using polyphosphoric acid, and asphalt having desirable properties may be produced with reduced air blowing times, reducing the cost of the process. Other advantages of the process will be apparent to those skilled in the art based upon the description of the invention provided below.

### DESCRIPTION OF THE FIGURES

FIG. 1 shows the results obtained using the process of the present invention for a combination of 90% slop and 10% vacuum residue.

FIG. 2 shows the results obtained using the process of the present invention for a combination of 70% asphalt and 30% vacuum residue.

FIG. 3 shows the results obtained using the process of the present invention for a combination of 70% asphalt and 30% vacuum residue.

FIG. 4 shows the change in softening point vs. time at about 250 minutes of air blowing without addition of PPA, and with the addition of PPA to achieve a PPA concentration by weight of 0.5%, 1% and 2%.

FIG. 5 shows the change in softening point vs. time at about 510 minutes of air blowing without addition of PPA, and with the addition of PPA to achieve a PPA concentration by weight of 0.5%, 1% and 2%.

### DETAILED DESCRIPTION OF THE INVENTION

It has been discovered that asphalts having enhanced properties can be produced using an air blowing oxidation process by first blowing air through the asphalt for a time reduced in comparison to a full air blowing process to produce a “semi-blown” asphalt. PPA is then added to the semi-blown asphalt. The addition of PPA to the semi-blown asphalt significantly increases the softening point without overly decreasing the penetration value. In addition, the desired properties can be achieved with a shorter blowing time.

The present invention contemplates the use of typical industrial asphalt air blowing equipment and procedures. The air blowing process may be performed at typical temperatures ranging from 350° F. to 550° F., and with air blown at rates of up to 3000 CFM. Semi-blown asphalt is produced by blowing the air through the asphalt for a time reduced as compared to a normal air blowing process. Air blowing for the process may be for a time between about 60 minutes to 700 minutes, preferably for a time of between about 200 and 300 minutes, and more preferably between about 225 and 260 minutes.

The PPA used in the present invention preferably is between 105% to 118% equivalent value. PPA is added to achieve a PPA concentration of between 0.1% by weight to 3% by weight. After addition of the PPA, the PPA and asphalt are stirred for the appropriate period of time to achieve good mixing, typically from 15 minutes to 10 hours. The PPA can be added while the asphalt is at the air blowing temperature used, or the asphalt can be allowed to cool prior to addition of the PPA. In one embodiment, the asphalt may be allowed to cool to 320° F. (160° C.) prior to addition of the PPA. The process is particularly desirable for use in modifying very PPA reactive asphalt types, or very PPA reactive combinations of asphalt with flux or slop.

If desired, other additives used in asphalt modification may be added to the asphalt. These additives may be added prior to the addition of PPA, with the PPA, or after the PPA has been added. Additives that may be incorporated in the modified asphalt include, for example, other acids, such as phosphoric acid, sulfuric acid, hydrochloric acid, organic acids or any other acid used to modify asphalt. Other additives typically used in the oxidation process, such as for example waxes or iron chloride, may also be added to the modified asphalt.

It should be understood that the precise conditions used to obtain asphalt having particularly desired properties will depend upon the origin of the crude oil used to produce the neat asphalt, the temperature and air flow, and the grade of PPA used. One skilled in the art can readily vary these parameters to obtain asphalt having the desired properties.

The following examples describe preferred embodiments of the invention. These examples are provided to illustrate particular embodiments of the process of the invention, and they are not intended to limit the scope of the invention in any way.

### EXAMPLE 1

Laboratory tests were performed to determine the properties of semi-blown asphalt with PPA added after the air blowing. To establish a baseline condition, air was blown through neat asphalt at a rate of 30 liters/min. The asphalt used was produced from a Russian crude oil. Samples of asphalt were removed and tested after various blowing times. The softening point and penetration depth after selected times for the baseline asphalt are shown in Table 1 below.

TABLE 1
Softening point and penetration versus time of neat asphalt
Blowing conditions: 440 F., 3 kg of asphalt

| Time | Softening Point | Penetration Depth (dm) |
|---|---|---|
| 120 | 32.8 | |
| 180 | 45 | |
| 230 | 59.1 | 60 |
| 255 | 66.2 | 45 |
| 300 | 77.9 | 32 |
| 365 | 95 | 20 |

Two samples of the same asphalt were processed by air blowing at the same temperatures and air flow rates as used for the baseline asphalt. In the first sample, air was blown through the asphalt for 230 minutes and PPA was added and stirred into the asphalt as described above. The PPA used was 105% H₃PO₄ equivalent and was added when the asphalt had cooled to a temperature of 320° F. (160° C.). In the second sample, air was blown through the asphalt for 255 minutes and 105% PPA was added with stirring as described above. The softening point and penetration values are set forth in Table 2 below.

TABLE 2
Post addition of 105% PPA on samples after
230 minutes and 255 minutes of blowing

| | | | |
|---|---|---|---|
| PPA Conc. | Softening Point (° C.) | Penetration (dmm) | Sieve |

Sample from 230 minutes air blowing

| | | | |
|---|---|---|---|
| 1% | 84.7 | 40 | Clean |
| 2% | 100 | 30 | Clean |

Sample from 255 minutes air blowing

| | | | |
|---|---|---|---|
| 1% | 95.6 | 31 | Clean |
| 2% | 111.5 | 25 | Clean |

As can be seen in Table 2 when compared to the neat asphalt in Table 1, the addition of PPA to asphalt following air blowing for 230 and 255 minutes show significant improvement in terms of softening point with a reduction in the penetration value. In addition, the samples were sieved following the addition of the PPA and no precipitates were identified as the sieves were clean.

### EXAMPLE 2

Asphalt samples were taken from an operating industrial blowing tower after about 255 minutes of air blowing and modified with PPA either 105% or 115% as described below. The air blowing was performed within the typical operating range of 400° F. to 550° F. The asphalt was produced from a Russian crude oil. Approximately 3 kg of the semi-blown asphalt was taken to the laboratory and mixed with PPA as described above in the proportions set forth in Tables 3 and 4 below. The softening point and penetration values for the samples are as shown.

TABLE 3

| | | | TESTS SP | | | | | | |
|---|---|---|---|---|---|---|---|---|---|
| | | | SP | Duplicate | Average | TESTS Pen (dmm) | | | |
| Samples | Bitumen | PPA 105% | (° C.) | (° C.) | (° C.) | 1 | 2 | 3 | Average |
| LabelA | 300 | 0 | 67.9 | 67.9 | 67.9 | 56.1 | 56.4 | 56.0 | 56.2 |
| LabelA + 1% | 297 | 3 | 97.7 | 97.3 | 97.5 | 35.7 | 39.8 | 37.7 | 38.8 |
| PPA | | | | | | | | | |
| LabelA + 1.5% | 295.5 | 4.5 | 105.4 | 105.2 | 105.3 | 32.6 | 32.2 | 36.1 | 34.2 |
| PPA | | | | | | | | | |
| LabelA + 2% | 294 | 6 | 106.7 | 106.7 | 106.7 | 29.2 | 28.6 | 28.1 | 28.4 |
| PPA | | | | | | | | | |

TABLE 4

| | | | TESTS SP | | | | | | |
|---|---|---|---|---|---|---|---|---|---|
| | | | SP | Duplicate | Average | TESTS Pen (dmm) | | | |
| Samples | Bitumen | PPA 115% | (° C.) | (° C.) | (° C.) | 1 | 2 | 3 | Average |
| LabelA | 300 | 0 | 67.0 | 67.2 | 67.1 | 58.6 | 58.4 | 58.1 | 58.3 |
| LabelA + 1% | 297 | 3 | 101.1 | 99.9 | 100.5 | 30.7 | 28.9 | 31.1 | 30.0 |
| PPA | | | | | | | | | |
| LabelA + 1.5% | 295.5 | 4.5 | 113.7 | 120.6 | 117.2 | 26.8 | 27 | 26.8 | 26.9 |
| PPA | | | | | | | | | |
| LabelA + 2% | 294 | 6 | 127.2 | 129.8 | 128.5 | 23.5 | 24.6 | 23.9 | 24.3 |
| PPA | | | | | | | | | |

As can be seen in Table 3 and 4, the softening point and penetration values show similar improvements to the control sample described in table 1 above.

The process of the present invention can be used with neat asphalt, or it may be used on mixtures of asphalt with flux, slop, or combinations of flux and slop. As known to those skilled in the art, flux and slop are the terms used to describe specific fractions obtained in a distillation tower. Typically, these are light fractions of distilled crude oil, and are often the last volatile fraction of the vacuum residue of crude oil distillation. These fractions may be combined with gas oil or diesel oil. In addition, the process may be used to improve the properties of combinations of flux and slop.

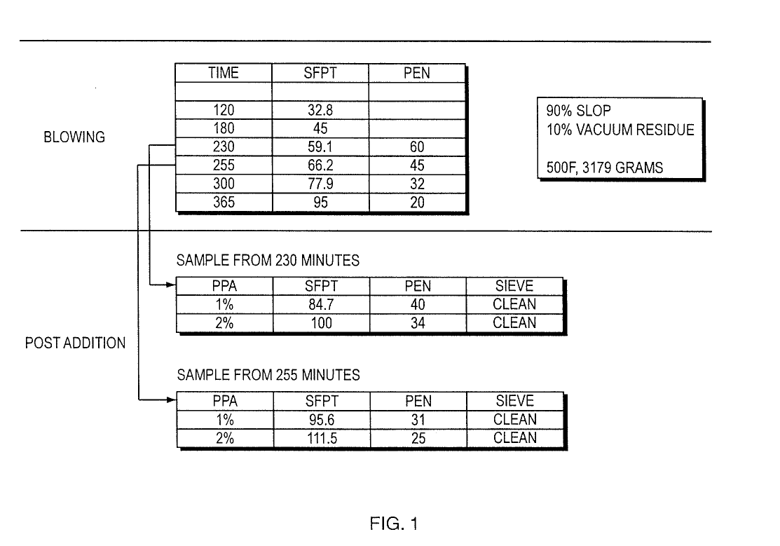

FIG. 1 shows the results obtained using a combination of 90% slop and 10% vacuum residue. Air was blown through the mixture at 500° F. Samples were obtained at the times shown in the Tables of FIG. 1 and tested for softening point and penetration value. At 230 minutes, a sample was removed and 105% PPA (referred to as Innovalt N200) was added to the mixture as described above. One sample had 1% by weight PPA added and the second had 2% by weight PPA added. As shown in the tables of FIG. 1, the mixture with the PPA added had superior properties to the mixture without PPA for the same time of air blowing.

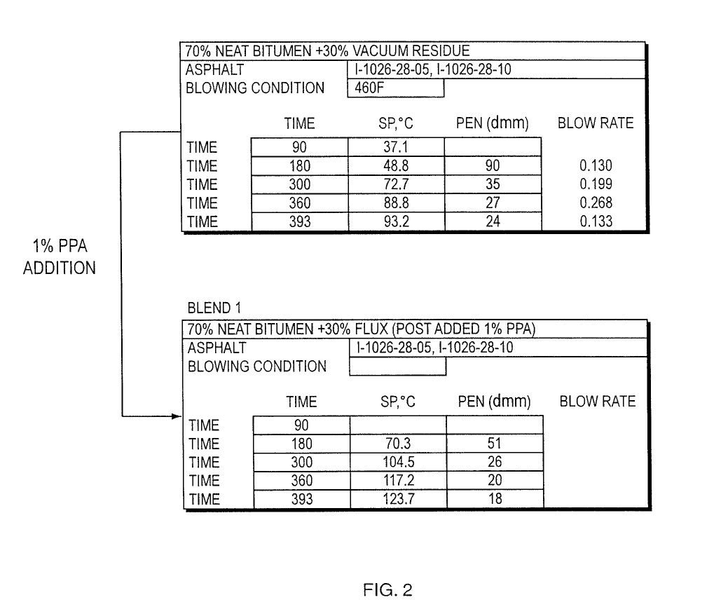

FIG. 2 shows the results obtained using a combination of 70% asphalt and 30% vacuum residue. Air was blown through the mixture at 460° F. Samples were obtained at the times shown in the Tables of FIG. 2 and tested for softening point and penetration value. The Table labeled “Blowing 5” shows the results for the asphalt/vacuum residue mixture without PPA, while the Table labeled “Blend 1” shows the results obtained by adding 1% by weight of 105% PPA added to a sample of the air blown asphalt/vacuum residue mixture as described above. As shown in the tables of FIG. 2, the mixtures with the PPA added had superior properties to the mixtures without PPA for the same time of air blowing.

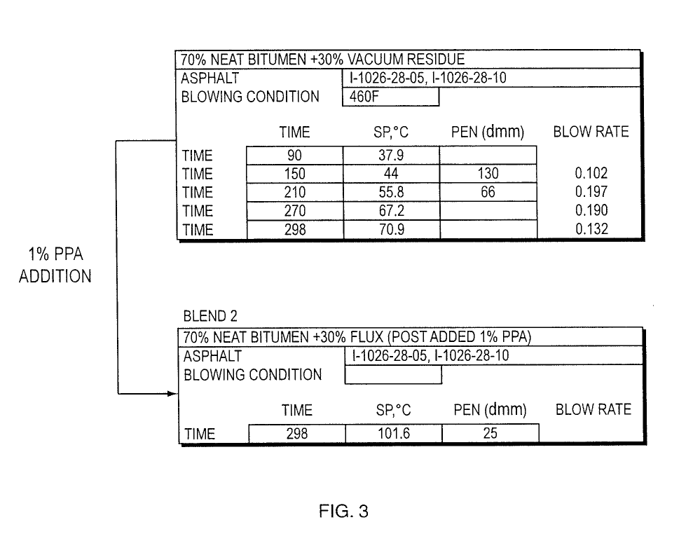

FIG. 3 shows the results obtained using a combination of 70% asphalt and 30% vacuum residue. Air was blown through the mixture at 460° F. A sample was obtained of the semi-blown asphalt after 298 minutes of air blowing and tested for softening point and penetration value. The Table labeled “Blowing 6” shows the results for the asphalt/vacuum residue mixture without PPA added, while the Table labeled “Blend 2” shows the results obtained by adding 1% by weight of 105% PPA to the sample of the air blown mixture. As shown in the Tables of FIG. 3, the mixtures with the PPA added had superior properties to the mixtures without PPA for the same time of air blowing.

Additional tests were conducted using Tricor Bakersfield Valero AC-1 asphalt blown with air at 450° F. The change in softening point and penetration depth for neat asphalt is summarized in Table 5. As can be seen from the table, it takes approximately 12 hours to achieve a softening point of about 100° C. and a penetration depth of about 17.

TABLE 5
Air Blowing Neat Bitumen at 450° F.

| | | Penetration | |
|---|---|---|---|
| Time (min) | Softening Point (° C.) | Depth (dmm) | Blow Rate (CFM) |
| 0 | 26.2 | | |
| 60 | 34.8 | | 0.143 |
| 180 | 43.7 | 126 | 0.074 |
| 270 | 50.9 | 65 | 0.080 |
| 390 | 54.4 | 38 | 0.029 |
| 510 | 76.6 | 28 | 0.029 |
| 600 | 90.6 | 21 | 0.029 |
| 730 | 105.6 | 17 | 0.029 |

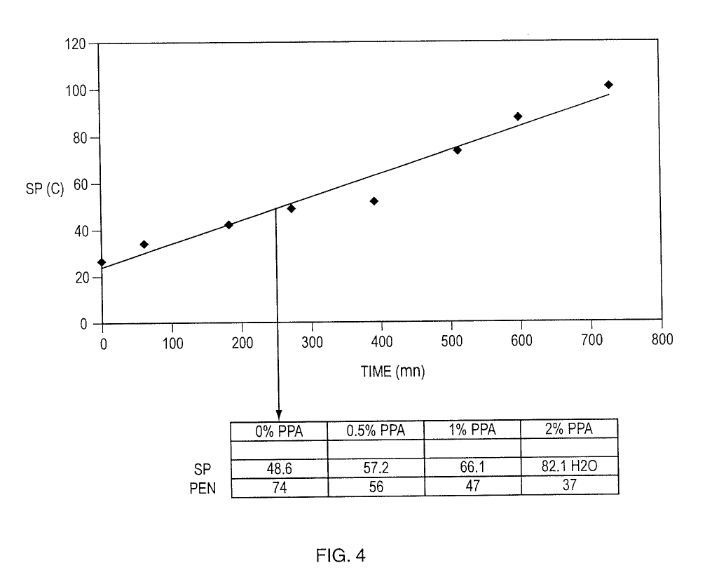

FIG. 4 shows the change in softening point vs. time. As shown in the table in FIG. 4, at about 250 minutes of air blowing without addition of PPA, the softening point is 48.6° C. and the penetration depth is 74 dmm. As shown in the table in FIG. 4, addition of PPA to achieve a PPA concentration by weight of 0.5%, 1% and 2% increase the softening point and decreases the penetration depth compared to the neat asphalt.

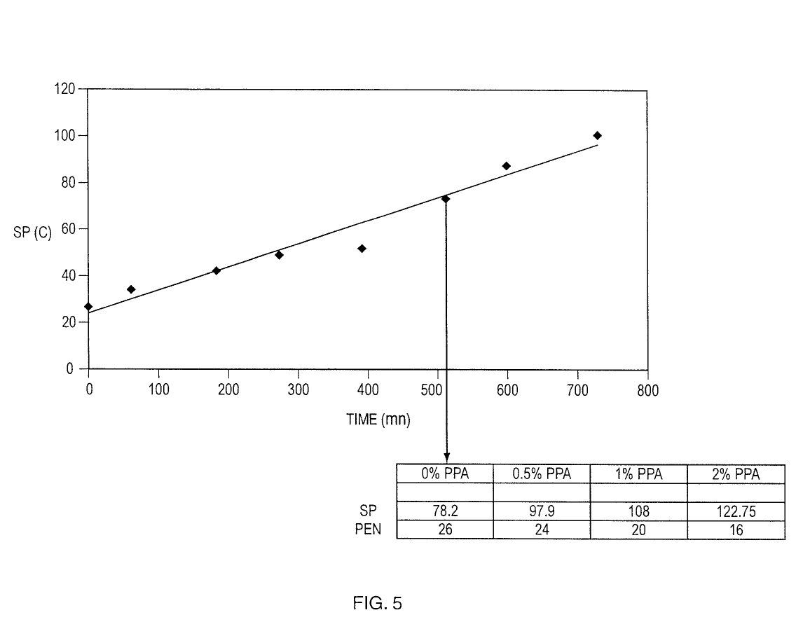

FIG. 5 shows the change in softening point vs. time. As shown in the table in FIG. 5, at about 510 minutes of air blowing without addition of PPA, the softening point is 78.2° C. and the penetration depth is 26 dmm. As shown in the table in FIG. 5, addition of PPA to achieve a PPA concentration by weight of 0.5%, 1% and 2% increase the softening point and decreases the penetration depth compared to the neat asphalt.

1. A process for producing an air blown asphalt comprising the steps of:
(a) providing an asphalt composition;
(b) treating the asphalt by air blowing for a period of time from 60 minutes to 700 minutes;
(c) following the air blowing treatment, adding polyphosphoric acid to the asphalt while stirring.

2. The process of claim 1, wherein the air blowing treatment is performed at a temperature from 350OF to 550° F.

3. The process of claim 2, wherein the polyphosphoric acid is from 105% to 118% equivalent value.

4. The process of claim 3, wherein the polyphosphoric acid is added to achieve a concentration from 0.1% by weight to 3% by weight.

5. The process of claim 4, wherein the asphalt and polyphosphoric mixture is stirred for a period of time from 15 minutes to 10 hours following the addition of the polyphosphoric acid.

6. The process of claim 5, wherein prior to air blowing, the asphalt is mixed with flux, slop, or combinations of flux and slop.

7. The process of claim 5, further comprising the step of cooling the asphalt prior to adding the polyphosphoric acid to a temperature from 300° F. to 340° F.

8. A process for producing an air blown asphalt comprising the steps of:
(a) providing an asphalt composition;
(b) treating the asphalt by air blowing at a temperature from 400° F. to 550° F. for a period of time from 200 minutes to 300 minutes;
(c) following the air blowing treatment, adding polyphosphoric acid having an equivalent value from 105% to 118% to the asphalt to achieve a concentration from 0.1% by weight to 3% by weight while stirring.

9. The process of claim 8, wherein the asphalt and polyphosphoric mixture is stirred for a period of time from 15 minutes to 10 hours following the addition of the polyphosphoric acid.

10. The process of claim 9, wherein prior to air blowing, the asphalt is mixed with flux, slop, or combinations of flux and slop.

11. The process of claim 10, further comprising the step of cooling the asphalt prior to adding the polyphosphoric acid to a temperature from 300° F. to 340° F.
